(19) United States
(12) Patent Application Publication
(10) Pub. No.: US 2021/0394947 A1
(43) Pub. Date: Dec. 23, 2021

(54) Monitoring apparatus for container handling plants

(71) Applicant: KRONES AG, Neutraubling (DE)

(72) Inventors: Wolfgang HAHN, Neutraubling (DE); Timo PRONOLD, Neutraubling (DE); Johannes BOEHM, Neutraubling (DE)

(21) Appl. No.: 17/391,944

(22) Filed: Aug. 2, 2021

Related U.S. Application Data
(63) Continuation of application No. 13/580,285, filed on Aug. 21, 2012.

(30) Foreign Application Priority Data
Feb. 23, 2010 (EP) 10 2010 009 137.5

(51) Int. Cl. B65C 9/40; B67B 3/26; B67C 3/00

(52) U.S. Cl. CPC B65C 9/40; B67C 3/007; B67B 3/26

(57) ABSTRACT

An apparatus for handling containers with a plurality of handling units for handling the containers, which handling units contain at least one filling device for filling the containers with a flowable medium, a closure device disposed downstream in a transport direction of the containers for closing the filled containers with closures, and with a labelling device for labelling the containers, and with a transport device for transporting the containers. The apparatus has at least one information output device, which is configured in such a way that it outputs information about the occurrence of malfunctions of the apparatus , wherein the information output device has at least one first information output element, which outputs a first information item about a specific malfunction in such a way that the first information item can be perceived in a first region and a second information output element which outputs a second information item about the same malfunction in such a way that the second information item can be perceived in a second region, wherein the first region and the second region are at least partially different.

### CROSS REFERENCE TO RELATED APPLICATION

The subject application is a continuation of U.S. patent application Ser. No. 13/580,285, filed Aug. 21, 2012, which in turn claimed priority to PCT/EP2011/052174, the contents of which are incorporated herein by reference.

### DESCRIPTION

The present invention relates to an apparatus for handling containers. A large number of such handling plants are known from the prior art, such as for example filling plants, which fill empty containers with a liquid such as a beverage. However, in addition plants such as transforming units for blow moulding of plastic parisons to form plastic containers, or transport or palletising equipment and the like are known.

The present invention is described with reference to a filling plant in which the invention proves particularly advantageous. However, it is pointed out that, if appropriate, the invention can also be used in other plants in the industrial sector which produce beverages.

A general tendency in such filling plants in the beverages industry is that the staffing costs and thus the number of operators should be reduced. One possibility for operating with lower staffing levels, if appropriate, consists of providing such plants with buffer means which can compensate for a temporary stoppage of a machine, for example as a consequence of a fault. However, because of the costs it is also desirable to reduce plant parts with functions which do not add value, such as for example transport equipment and buffers. In addition a further concern is to reduce the space required for such plants.

Ideally such filling plants should be operated largely without staff, but on the other hand buffers and transport routes, which in the past helped to bypass malfunctions, are avoided. However, in this case it should be borne in mind that even a plant which is almost perfectly equipped in terms of machinery has to process material which on occasions is not optimised in terms of cost and in terms of processing for the product to be produced, and thus can cause malfunctions. In addition, disruptions can result from the interaction of machines and material.

Therefore the object of the present invention is to provide a handling plant for containers, which on the one hand can be operated with a small number of staff and which on the other hand also largely dispenses with factors which do not add value and which are used to bypass malfunctions. This is achieved according to the invention by an apparatus as claimed in claim 1. Advantageous embodiments and modifications are the subject matter of the subordinate claims.

An apparatus according to the invention for handling containers has a plurality of handling units for handling the containers, wherein the handling units contain at least one filling device for filling the containers with a liquid medium, a closure device disposed downstream in a container transport device for closing the filled containers with closures, and preferably also with a labelling device for labelling the containers. Furthermore the machine also has a transport device for transporting the containers.

According to the invention the apparatus has at least one information output device, which is configured in such a way that it outputs information about the occurrence of malfunctions of the apparatus, wherein the information output device has at least one first information output element which outputs a first information item about a specific malfunction in such a way that the first information item can be perceived in a first region and a second information output element which outputs a second information item about the same malfunction in such a way that the second information item can be perceived in a second region, wherein the first region and the second region are at least partially different.

It is therefore proposed to output information about malfunctions on different areas of the apparatus so that in the most efficient manner possible a few staff or only one user is/are informed about the occurring malfunction regardless of their location.

The information output device preferably provides information about malfunctions occurring during operation of the apparatus. In a further advantageous embodiment the apparatus also has a transforming device which transforms plastic parisons into plastic containers. This transforming device is in particular a so-called stretch blow moulding machine having a stretching rod which also expands the containers in the longitudinal direction.

It is therefore proposed to install a plant malfunction and information management system in order to reduce the consequences of these malfunctions or to reduce the duration of the malfunctions.

Advantageously the second region encloses the first region geometrically at least partially and advantageously completely. Thus it is possible that the first region is a proximal region relative to an operating means or a display and the second region is the working area in which the user the usually stops the plant.

In a further advantageous embodiment at least one information output element is designed in such a way that it outputs information about the location of a malfunction and/or information about it which is characteristic of the malfunction or the correction of the malfunction. Therefore the staff responsible for the plant advantageously obtain information about the fact that a malfunction has occurred, advantageously also about where in the plant the malfunction is located, more advantageously where on the individual machine the malfunction is located and finally also information about the malfunction itself or information about the cause and the correction of the malfunction.

Thus the user is able to correct malfunctions quickly and effectively and to start the production again. Thus the present invention is applicable in particular to large plants in which the exact location of the malfunction can be displayed very quickly to the user. Thus for example an information output element can provide information to the effect that (somewhere in the plant) a malfunction has occurred.

A further information output element provides information to the user about the location on the plant, for example in the filler, where the malfunction has occurred. A further information output element provides information to the user as to where on a specific machine, i.e. in this case where on the filling device, the malfunction lies. Therefore the information items from the individual information output elements advantageously relate to the same malfunction, but these information output elements advantageously exhibit different characteristics of the malfunction for example with regard to of the location of the malfunction. Thus, starting from the information that there is a malfunction, the user can obtain ever more detailed information about the malfunction via further information output elements. Thus advantageously all information output elements are designed in such a way that they output information about the location or the malfunction itself, wherein however the output information items are advantageously different and are also dependent upon the region in which the information is output.

In a further advantageous embodiment the apparatus has an input unit via which commands can be passed to the machine by a user. This input unit may for example be an input field such as a touchpad via which the user passes his commands to the machine.

Advantageously the apparatus has a third information output element which outputs a third information item about the malfunction in such a way that the information can be perceived in a predetermined third region, wherein the third region differs from both the first region and the second region. The third region encloses the second region and preferably also at least one first region, advantageously a plurality of first regions geometrically at least partially and advantageously completely. Thus a third region encloses a plurality of second regions and these second regions in turn can enclose a plurality of first regions.

In particular by the output of the information on at least three levels a specific malfunction can be located quickly in a particularly efficient manner.

In a further advantageous embodiment at least one region is selected from a group of regions which includes an immediate geometric region around the input unit, a working region of a user of the apparatus, a higher-level region for a plurality of handling units and a higher-level region of the entire apparatus.

Thus a reporting system on at least two levels is proposed here, in particular for a filling plant. In this case the first level may be a region on or in the machine or on the operating unit. In this case this information output element can output detailed information and/or also the display of a malfunction location on the operating element and/or in the machine, such as for example the identification of a malfunction location by means of a light source.

At the second level this may be a proximal region of the machine, i.e. a working area of the operator. An indicator light and/or a siren can for example be provided here.

Furthermore a higher level for a plurality of machine groups or for the entire plant may be provided as the third level.

Furthermore it would also be possible that a further level is not limited substantially locally, so that for example a report is output to a user by radio or mobile telephone. These information output elements preferably output information about essential main functions of the plant, for example blow moulding, filling, labelling, packing and also palletising.

Therefore in a further advantageous embodiment at least one information output element is disposed on the input unit.

Advantageously is even at least one information output element is selected from a group of information output elements, which include elements with acoustic output, elements with optical output, elements with tactile output, lighting means, sirens, combinations thereof and the like.

Advantageously at least one information output element also only outputs information relating to precisely one handling unit. This may for example be a proximal region level, so that the user can recognise that the assigned information output element relates to this specific machine part.

In a further advantageous embodiment at least one information output element is configured in such a way that it outputs different information items which relate to different handling units. This may preferably be a higher-level information output element to which a plurality of plant parts are assigned. Thus this may for example be a higher-level information output element to which both the filler and the labelling machine are assigned.

The region in which this information output element outputs the information may be a working area of the user.

Therefore advantageously more possible fault locations are assigned to the second information output element than to the first information output element.

In a further advantageous embodiment at least one information output element is configured in such a way that it outputs information items which relate to any region of the whole apparatus. This may for example be a warning light which indicates to the user that a fault has occurred somewhere in the plant.

In a further advantageous embodiment at least one information output element is configured in such a way that it outputs information to a receiving device which is outside a region of the machine. Thus for example an output to a radio device or a mobile telephone may be provided.

In a further advantageous embodiment output characteristics the information output by at least one information element output can be varied. Thus it is possible for example that the volume can be varied, that intervals of an acoustic signal can be varied, or also the brightness and the like. Thus it is proposed here that the individual information output elements can be adapted individually to the installation situation of the plant, for example the use of signal lamps and horns or sirens, which allow different tones, intervals and volumes and the like. It is also possible that the individual regions in which the information can be perceived can be varied, for example due to pivotability of an information output element or the like.

In this case it is preferably possible that the output characteristics can be varied via the input device of the apparatus by the client itself. In this way the particular operator situation (one or more machine operators) and the visibility of the machines for example from the position of the supply unit (parisons, closures, packaging material, etc.) can be taken into account.

In a further advantageous embodiment the apparatus has at least one sensor unit which detects or can detect a malfunction of the apparatus. In this case it is possible that this sensor unit communicates directly or indirectly with the information output elements, so that they can output information about this malfunction. Furthermore the apparatus advantageously has a memory unit in which procedures for correcting specific malfunctions are stored.

Advantageously a transport path along which the containers are conveyed through the apparatus also remains constant in the event of a malfunction. It is therefore proposed that no buffer routes or the like are provided on which the containers can divert. The drive costs for the apparatus can be reduced by this procedure in conjunction with the invention.

In a further advantageous embodiment the apparatus has a control unit, which causes at least two information output elements to output information about the same malfunction substantially simultaneously. However, it would also be possible that first of all the information output element which can be perceived in the largest area outputs the information and then further information output elements do so. Due to the substantially simultaneous output the user can also be led very quickly to the location of the malfunction.

In a further advantageous embodiment at least two handling units are each assigned to a first information output element and these two first information output elements are in turn assigned to a further information output element. The number of first information output elements is advantageously higher than the number of second information output elements. In this case an assignment is understood to mean that information about a specific malfunction is output to the information output elements which are assigned to one another.

In a further advantageous embodiment the apparatus has a packaging unit which produces packs from a plurality of containers. In a further advantageous embodiment the apparatus also has a palletising unit which assembles a plurality of packs into layers of packs and also an apparatus which produces pallets from a plurality of layers.

Further advantages and embodiments are apparent from the appended drawings, in which:

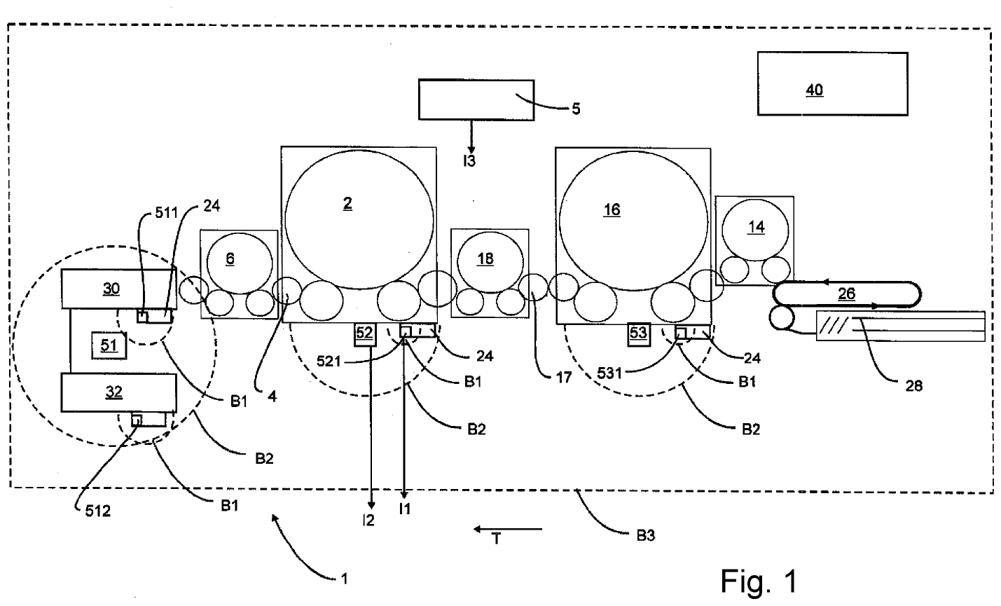

FIG. 1 shows a schematic representation of an apparatus according to the invention; and

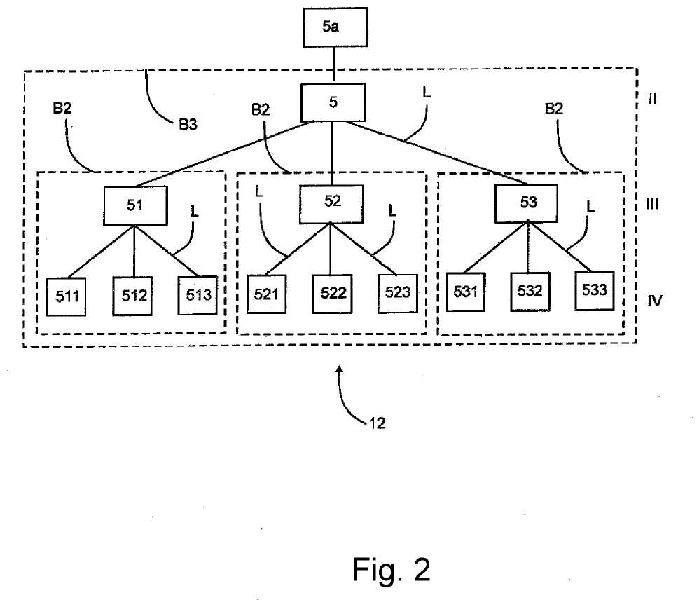

FIG. 2 shows a representation to illustrate the interaction of the information output elements.

FIG. 1 shows a schematic representation of an apparatus according to the invention.

This has a feeding unit 28 for plastic parisons such as for example a roller grader. Starting from this roller grader 28 the plastic parisons pass through a furnace 26 and into a transforming device 16 which transforms the plastic parisons into plastic containers. In this case a sterilising unit 14 can also be provided for sterilising the plastic parisons.

Starting from the transforming device 16 the containers produced in this way pass via a further transport device 17, optionally a further sterilising unit 18, to a filling device 2 which fills the containers with a liquid and in particular a beverage. In the transport direction T of the containers a closure device 4 for closing the containers adjoins this filling device 2, followed by a labelling device 6 for labelling the containers. The reference 30 identifies quite schematically a collating device which collates a large number of containers to form a pack, and the reference 32 relates, equally schematically, to a palletiser.

The reference 5 relates to a third information output element, which is disposed at a higher level, so that signals which are output by this third information output element 5 can be picked up in the region B3 which in principle comprises the entire plant. The reference 13 identifies the information output by the third information output element 5. This may for example be merely the information that a malfunction has occurred somewhere in the plant.

Simultaneously with the output of this information the machine can for example be stopped.

The references 51, 52 and 53 each relate to second information output elements which are disposed on different plant parts, such as in this case the filling device, the transforming device 16 and the palletiser region. In this case these regions are each individually identified by the references B2. All the regions B2 lie within the large region B3. Information items 12 which relate to the malfunction are in turn output on these information output elements 51, 52 and 53.

The references 511, 512, 521 and 531 each denote first information output elements which in this case are each disposed on input devices 24 for operating the machine in the part of the plant. Accordingly the regions B1 in which signals output by these information output elements 511, 512, 521, 531 can be perceived are smaller and are each inside the regions B2 assigned thereto. A plurality of information output elements 511, 512, 521, 531 could also be disposed within the region B2. The reference 11 relates to the information output by the first information output elements.

The reference numeral 40 identifies a control unit for controlling the plant. In this case this control unit can also control the information output device, i.e. in particular the interaction of the individual information output elements and can for example assign to a specific malfunction those information output elements which output this malfunction to the user.

FIG. 2 shows a diagram of an information output device 12 for output of the particular information on the malfunctions. In this case a higher-level information output element 5 is again provided, to which three second information output elements 51, 52 and 53 are assigned in this example. Three information output elements 511, 512, 513; 521, 522, 523; 531, 532, 533 are in turn assigned to each of these second information output elements. In this case this assignment is represented by the respective connecting lines L. This assignment is understood so that at one of the assigned information output elements in each case information about a certain malfunction is output, and is also output on the higher-level information output element (for example 51-53).

In this case the third information output element 5 is assigned to the entire plant, the second information output elements 51, 52 and 53 are assigned to individual plant areas and the first information output elements 511, 512, 513; 521, 522, 523; 531, 532, 533 are each assigned to specific plant parts. These first information output elements 511-533 are therefore assigned to specific machine parts. In this case the regions B1 (not shown) are the respective proximal regions of the relevant information output element 511 . . . 533. However it is pointed out that the location of the malfunction may also differ from the location of the first information output elements 511 . . . 533.

If for example a malfunction to which the first information output element 512 is assigned occurs on a machine part, then this information output element 512 will output an information item about the malfunction. However, substantially at the same time the second information output element 51 and the third information output element 5 will also output an information item about the malfunction. Thus regardless of where the user is he can quickly reach the location of the actual malfunction.

Optionally the information output element 5 can also be assigned to a further higher-level information output element 5a and can for example be in radio communication therewith. This further information output element 5a may for example be a remote computer or a user's mobile telephone, so that in the event of malfunction a user is informed about this by mobile telephone.

It will be seen in FIG. 2 that this arrangement can be changed both with regard to the number of information output elements and with regard to the cascading depth. However, it has been ascertained that at least three of the four levels I to IV shown here are useful in order to provide efficient malfunction management.

The applicant reserves the right to claim all the features disclosed in the application documents as essential to the invention in so far as they are individually or in combination novel over the prior art.

### LIST OF REFERENCE NUMERALS

1 apparatus

2 filling device

4 closure device

5, 5a third information output element

6 labelling device

12 information output device

14 sterilising unit

16 transforming device

17 transport device

18 sterilising unit

24 input device

26 furnace

28 feeding unit, roller grader

30 collating device

32 palletiser

40 control unit

51, 52, 53 second information output element

511, 512,513,

521, 522, 523,

531, 532, 533 first information output element

T transport direction

11, 12, 13 output information

B1 first region

B2 second region

B3 third region

I-IV levels

L connecting lines

1. An apparatus for treating containers with a plurality of treating units for treating the containers, which treating units contain at least one filling device for filling the containers with a flowable medium, a closure device disposed downstream in a transport direction of the containers for closing the filled containers with closures, and with a labelling device for labelling the containers, and with a transport device for transporting the containers, wherein the apparatus has at least one information output device, which is configured in such a way that it outputs information about the occurrence of malfunctions of the apparatus to a user, wherein the information output device has at least one first information output element, which outputs a first information item about a specific malfunction to the user in such a way that the first information item can be perceived in a first region and a second information output element which outputs a second information item about the same specific malfunction to the user in such a way that the second information item can be perceived in a second region, wherein the first region and the second region are at least partially different, characterized in that the second region completely encloses the first region geometrically and that the apparatus has a third information output element which outputs a third information about the malfunction in such a way that the information in a predefined third region can be perceived, wherein the third region differs both from the first region and the second region and the third region completely encloses the first region of at least one first information output element and the second region of the second information output element geometrically.

2. The apparatus as claimed in claim 1, wherein at least one information output element is designed in such a way that it outputs information about the location of a malfunction and/or information which are characteristic of the malfunction or the correction thereof.

3. The apparatus as claimed in claim 1, wherein the apparatus has an input unit via which commands can be passed to the apparatus by a user.

4. The apparatus as claimed in claim 1, wherein at least one region is selected from a group of regions which includes an immediate geometric region around the input unit, a working region of a user of the apparatus, a higher-level region for a plurality of treating units and a higher-level region of the entire apparatus.

5. The apparatus as claimed in claim 1, wherein at least one information output element only outputs information relating to precisely one treating unit.

6. The apparatus as claimed in claim 1, wherein at least one information output element is configured in such a way that it outputs different information items which relate to different treating units.

7. The apparatus as claimed in claim 1, wherein a transport path along which the containers are conveyed through the machine remains constant.

8. The apparatus as claimed in claim 1, wherein a respective first information output element is assigned to at least two treating units and these information output elements are assigned to an information output element.

9. The apparatus as claimed in claim 2, wherein the apparatus has an input unit via which commands can be passed to the apparatus by a user.

10. The apparatus as claimed in claim 2, wherein at least one region is selected from a group of regions which includes an immediate geometric region around the input unit, a working region of a user of the apparatus, a higher-level region for a plurality of treating units and a higher-level region of the entire apparatus.

11. The apparatus as claimed in claim 2, wherein at least one information output element only outputs information relating to precisely one treating unit.

12. The apparatus as claimed in claim 2, wherein at least one information output element is configured in such a way that it outputs different information items which relate to different treating units.

13. The apparatus as claimed in claim 2, wherein a transport path along which the containers are conveyed through the machine remains constant.

14. The apparatus as claimed in claim 2, wherein a respective first information output element is assigned to at least two treating units and these information output elements are assigned to an information output element.

15. The apparatus as claimed in claim 3, wherein at least one region is selected from a group of regions which includes an immediate geometric region around the input unit, a working region of a user of the apparatus, a higher-level region for a plurality of treating units and a higher-level region of the entire apparatus.

16. The apparatus as claimed in claim 3, wherein at least one information output element only outputs information relating to precisely one treating unit.

17. The apparatus as claimed in claim 3, wherein at least one information output element is configured in such a way that it outputs different information items which relate to different treating units.

18. The apparatus as claimed in claim 3, wherein a transport path along which the containers are conveyed through the machine remains constant.

19. The apparatus as claimed in claim 3, wherein a respective first information output element is assigned to at least two treating units and these information output elements are assigned to an information output element.

20. The apparatus as claimed in claim 4, wherein at least one information output element only outputs information relating to precisely one treating unit.
